(19) United States
(12) Patent Application Publication
(10) Pub. No.: US 2004/0104920 A1
(43) Pub. Date: Jun. 3, 2004

(54) Image display method for mobile terminal in image distribution system, and image conversion apparatus and mobile terminal using the method

(76) Inventors: Tsuyoshi Kawabe, Tokyo (JP); Hirotada Ueda, Kokubunji (JP); Mitsue Ito, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/659,356

(22) Filed: Sep. 11, 2003

(30) Foreign Application Priority Data
Sep. 30, 2002 (JP) 2002-284872

(51) Int. Cl. G09G 5/00

(52) U.S. Cl. 345/660

(57) ABSTRACT

An image distribution system includes an image storage distribution apparatus for storing images picked up by an imaging unit and an image conversion apparatus for obtaining an image from the image storage distribution apparatus if the image is required by a mobile terminal and then distributing the image to the mobile terminal. In this system, a frame for selecting an image range to be enlarged is displayed on the stored image displayed on the mobile terminal. The frame may be optionally moved or changed in size. With this frame, the desirous range of the image is enlarged multiple times, and the enlarged image is displayed on the mobile terminal.

### BACKGROUND OF THE INVENTION

The present invention relates to an image display method for a mobile terminal in an image distribution system, and an image conversion apparatus and a mobile terminal using the method, which are all arranged so that images stored in an image storage distribution apparatus may be viewed on the mobile terminal in the image distribution system provided with one or more mobile terminals.

Today, the technologies of storing and distributing images through a network such as the internet or the LAN have been developed for the purpose of monitoring an object such as an intruder with a monitoring camera. Moreover, the new technology has been also developed of viewing the images stored in the image storage distribution apparatus with a mobile terminal such as a portable phone or a PDA (Personal Digital Assistant).

The method of viewing the images stored in the image storage distribution apparatus through the conventional mobile terminal will be briefly described below.

In the typical image distribution system, conventionally, the mobile terminals are connected with the image storage distribution system through a transmission path like the WAN (Wide Area Network), and the image storage distribution system is connected with the monitoring camera through a transmission path like the LAN (Local Area Network). The image storage distribution apparatus is constantly storing the images sent from the monitoring camera.

In the foregoing prior art,-the monitoring camera is installed in a site to be monitored. Then, the images are picked up in the site and then transmitted to and stored in the image storage distribution apparatus through the transmission path like the LAN. The images stored in the image storage distribution apparatus are transmitted to the mobile terminal by handling the mobile terminal itself. The images are displayed on the mobile terminal so that the user may view the images sent from the monitoring camera.

### SUMMARY OF THE INVENTION

In general, however, the mobile terminal is equipped with a small screen with a relatively small number of pixels. If, therefore, the monitoring camera can pick up clear images, one or more portions of the image required for monitoring the target site may be obscure on the mobile terminal, so that the target site may not be clearly checked.

It is therefore an object of the present invention to provide an image display method for a mobile terminal in an image distribution system, and an image conversion apparatus and a mobile terminal using the method, which are arranged so that the required portion(s) of the monitored image to be viewed on the mobile terminal may be clearly displayed on the mobile terminal.

According to an aspect of the present invention, the image distribution system includes: an image storage distribution apparatus for accumulating images picked up by an imaging unit; an image conversion apparatus for, if a mobile terminal requests to display an image specified by the mobile terminal, obtaining the specified image from the image storage distribution apparatus, and distributing the specified image to the mobile terminal; the mobile terminal for displaying the image distributed from the image conversion apparatus on screen of a monitoring unit, specifying an optional location and area of the displayed image, and transmitting information on the specified location and area to the image conversion apparatus, and wherein the image conversion apparatus enlarges the image portion of the location and area specified on the mobile terminal to the display size of the monitoring unit of the mobile terminal and distributes the enlarged image onto the mobile terminal, and the mobile terminal displays the enlarged image distributed from the image conversion apparatus on the screen of the monitoring unit.

According to another aspect of the present invention, by displaying the optional location and area of the image with a frame and then handling the frame on the mobile terminal, the optional location and area of the image may be specified.

According to another aspect of the present invention, by arbitrarily changing the optional location and area of the image, it is possible to adjust the enlarging location and area.

The foregoing embodiments of the present invention make it possible to easily check the details of the image on the mobile terminal with a smaller display area than that of the ordinary personal computer or the like.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an arrangement of an image distribution system according to an embodiment of the present invention;

FIG. 2A is a view showing an outer appearance of a mobile terminal included in an image distribution system according to an embodiment of the present invention;

FIG. 2B is a block diagram showing an arrangement of the mobile terminal included in the image distribution system according to the embodiment of the present invention;

FIG. 3 is a block diagram showing an arrangement of an image conversion apparatus included in the image distribution system according to the embodiment of the present invention;

FIG. 4 is a block diagram showing an arrangement of an image storage distribution apparatus included in the image distribution system according to the embodiment of the present invention;

FIG. 5 is a flowchart showing a first method of viewing images stored in the image storage distribution apparatus using the mobile terminal;

FIG. 6 is a view showing a monitoring screen of the mobile terminal on which a frame for selecting an image portion to be enlarged is displayed;

FIG. 7 is a view showing enlargement or reduction of the frame on the monitoring screen of the mobile terminal;

FIG. 8 is a view showing a further enlarged frame appearing on the enlarged image displayed on the monitoring screen of the mobile terminal;

FIG. 9 is an explanatory view showing the method of calculating an image selecting area in the second or later process of enlarging the image;

FIG. 10 is a view showing a further enlargement of the monitored image enlarged on the monitoring screen of the mobile terminal;

FIG. 11 is a flowchart showing a second method of viewing the images stored in the image storage distribution apparatus using the mobile terminal; and

FIG. 12 is a flowchart showing a third method of viewing the images stored in the image storage distribution apparatus using the mobile terminal.

### DETAILED DESCRIPTION OF THE EMBODIMENTS

Later, the description will be oriented to the image display method for the mobile terminal in the image distribution system, and the image conversion apparatus and the mobile terminal using the method according to the present invention with reference to the appended drawings.

In the following description, the elements or the processes having the same functions are given the same reference numbers for the purpose of avoiding the duplication of the description.

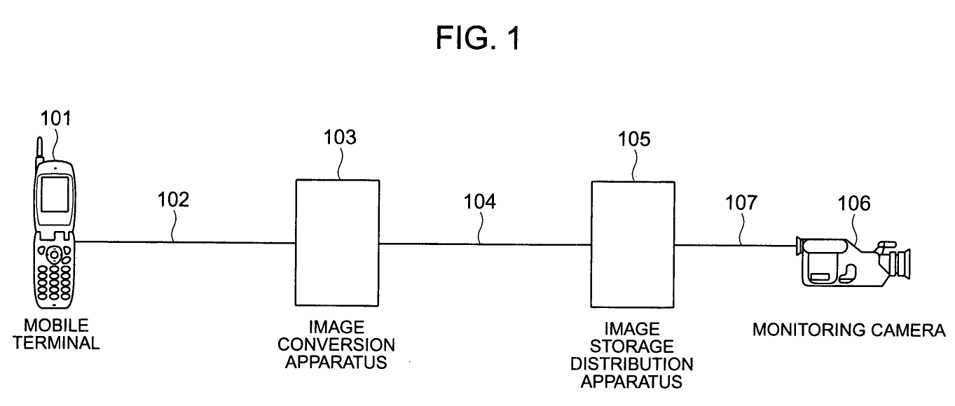

FIG. 1 is a block diagram showing an image distribution system arranged to view images stored in the image storage distribution apparatus using the mobile terminal.

A numeral 101 denotes a mobile terminal, which is connected with an image conversion apparatus 103 through a transmission path 102 like a WAN (Wide Area Network). The image conversion apparatus 103 is connected with an image storage distribution apparatus 105 through a transmission path 104 like a LAN (Local Area Network). Then, the image storage distribution apparatus 105 is connected with a monitoring camera 106 through a transmission path 107 like a LAN. The transmission path 104 or 107 may be a wireless one.

The image storage distribution apparatus 105 is constantly storing images picked up by the monitoring camera 106, for example.

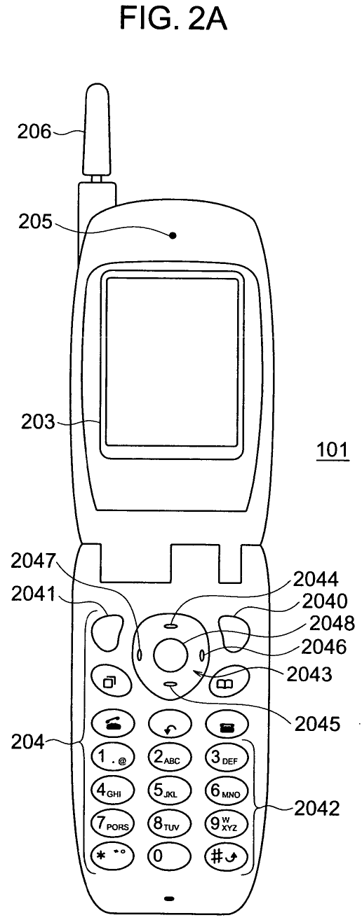

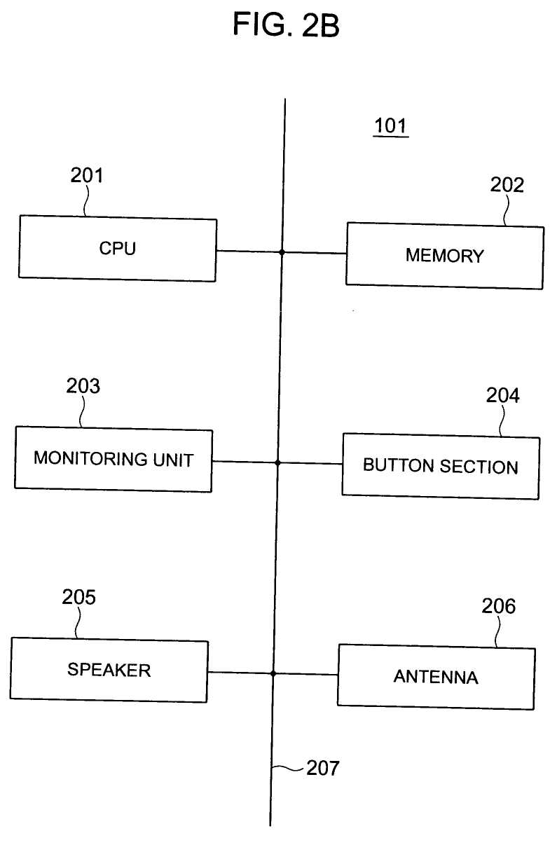

FIG. 2A shows an outer appearance of the mobile terminal 101 shown in FIG. 1. FIG. 2B is a block diagram showing the arrangement of the mobile terminal 101. As shown in FIGS. 2A and 2B, herein, the mobile terminal 101 is a portable phone, which is arranged to have a CPU (Central Processing Unit) 201, a memory 202 including a ROM and a RAM, a monitoring unit 203, a button section 204, a speaker 205, an antenna 206, and a bus 207 connecting them with one another. The button section 204 includes, as an example, a cross key 2043, soft keys 2040 and 2041 located in the right and the left hands, and numeric keys 2042.

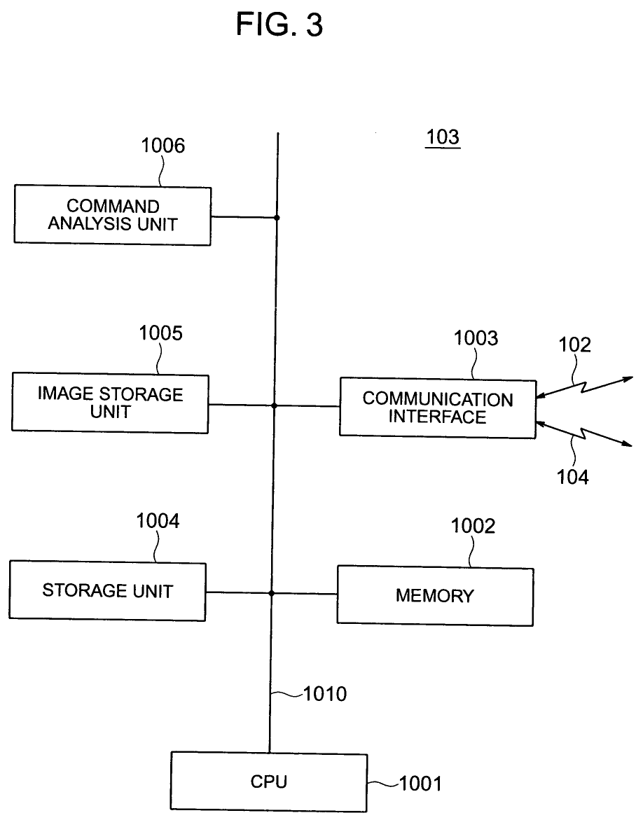

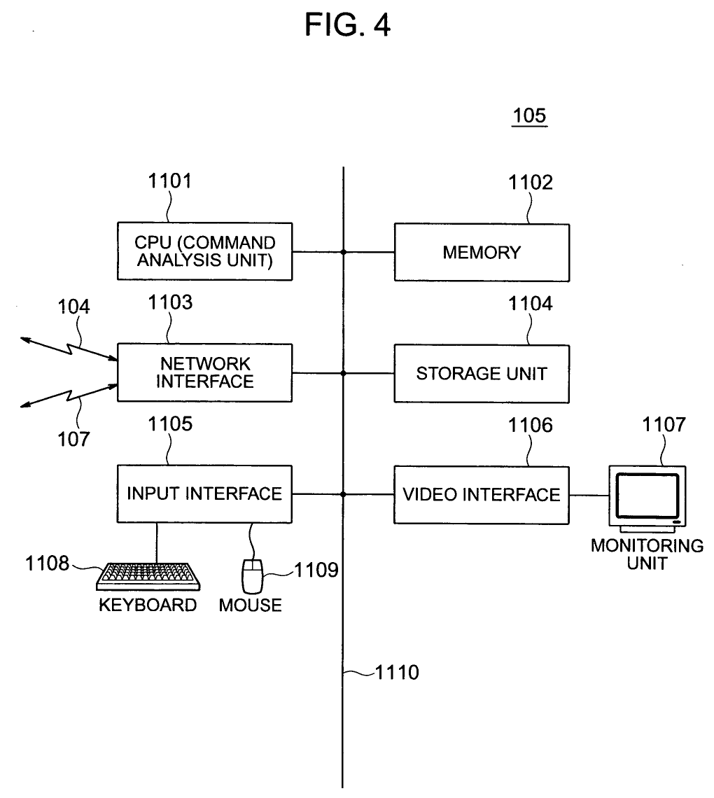

FIG. 3 shows a block diagram showing an arrangement of the image conversion apparatus 103. FIG. 4 is a block diagram showing an arrangement of the image storage distribution apparatus 105.

In FIG. 3, the image conversion apparatus 103 includes a communication interface (network interface) 1003 connected with the transmission paths 102 and 104, a memory 1002 including a ROM and a RAM, a CPU 1001, a storage unit 1004 like a harddisk or a DVD for recording an image, an image conversion unit 1005, a command analysis unit 1006, and a bus 1010 connecting them with one another.

The command analysis unit 1006 operates to analyze commands such as various kinds of requests to be inputted from the transmission path through the communication interface 1003 and then perform the processes for the commands. It may be included in the CPU 1001.

In FIG. 4, the image storage distribution apparatus 105 includes a network interface (communication interface) 1103 connected with the transmission paths 104 and 107, a memory 1102 including a ROM and a RAM, a CPU 1101, a storage unit 1004 like a harddisk or a DVD for recording images, an input interface 1105 connected with an input terminal like a keyboard 1108 and a mouse 1109, a video interface 1106 connected with a monitoring unit 1107, and a bus 1110 connecting them with one another.

The CPU 1101 includes a command analysis unit, which operates to analyze commands like various kinds of requests to be inputted from the transmission path through the network interface 1103 and perform the processes for these commands. In this embodiment, the command analysis unit is included in the CPU 1101. In place, it may be separated from the CPU.

Moreover, the monitoring unit 1107 and the video interface 1106 are used for monitoring the images picked up by the monitoring camera 106 or stored in the storage unit 1104. They are not necessarily provided in this arrangement.

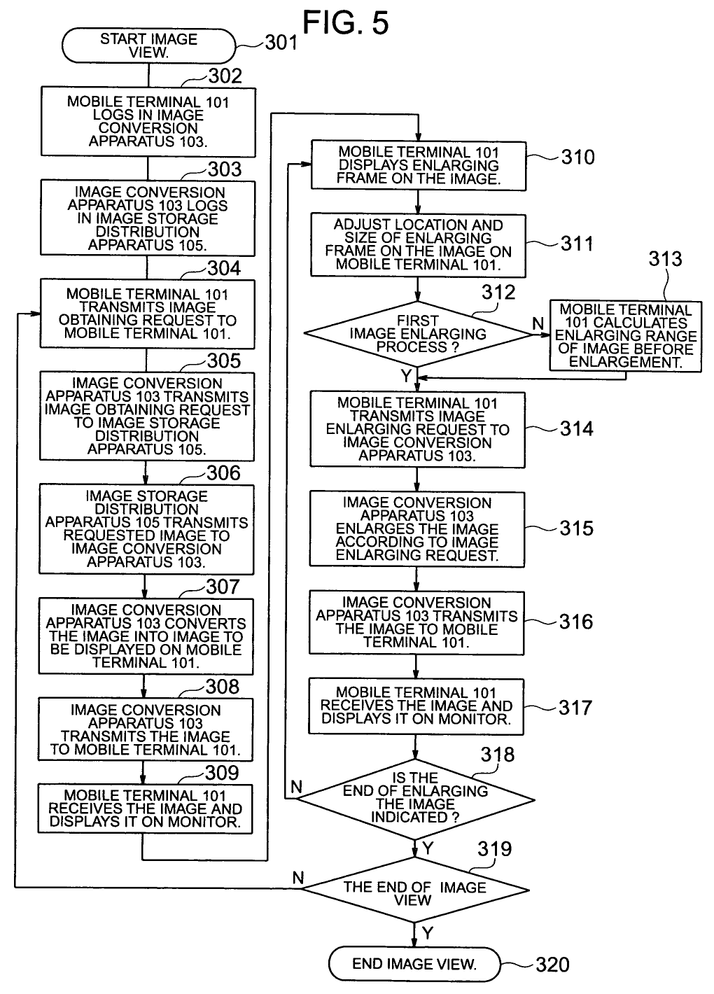

FIG. 5 is a flowchart showing a first method of viewing the images stored in the image storage distribution apparatus 105 using the mobile terminal 101. In the following description, the operations of the mobile terminal 101, the image conversion apparatus 103, and the image storage distribution apparatus 105 are executed by the softwares stored in the memory 202 of the mobile terminal 101, the memory 1002 of the image conversion apparatus 103, and the memory 1102 of the image storage distribution apparatus 105, respectively.

In a step 301, the process is started of viewing the images stored in the image storage distribution apparatus 105 using the mobile terminal 101. For example, by handling the button section 204 located on the mobile terminal 101, the image viewing software is executed. In a step 302, the mobile terminal 101 is logged (connected) in the image conversion apparatus 103. In a step 303, the image conversion apparatus 103 is logged (connected) in the image storage distribution apparatus 105. The log-in process in the image conversion apparatus 103 is executed by the command analysis unit 1006 through the communication interface 1003. The log-in process in the image storage distribution apparatus 105 is executed in the CPU 1101 through the network interface 1103.

In a step 304, the mobile terminal 101 operates to transmit the requesting command for obtaining (distributing) the images stored in the image storage distribution apparatus 105 from the CPU 201 to the image conversion apparatus 103 through an antenna 206 and the transmission path 102. In this process, the user of the mobile terminal 101 specifies a target image of the images stored in the image storage distribution apparatus 105 by handling the button section 204 of the mobile terminal 101. Then, the mobile terminal 101 operates to transmit the requesting command for obtaining (distributing) the target image. In a step 305, in response to the command, the command analysis unit 1006 included in the image conversion apparatus 103 transmits the requesting command for obtaining (distributing) the specified image to the image storage distribution apparatus 105 through the communication interface 1003 and the transmission path 104.

In a step 306, in the image storage distribution apparatus 105, the CPU 1101 receives the requesting command for obtaining (distributing) the image through the network interface 1103, reads the requested image from the storage unit 104, and then transmits the image to the image conversion apparatus 103 through the network interface 1103 and the transmission path 104.

In a step 307, the image conversion apparatus 103 receives the image transmitted from the image storage distribution apparatus 105 in the communication interface 1003, stores the image in the storage unit 1004, and converts the image into the corresponding image with the screen size of the mobile terminal 101 in the image conversion unit 1005, and then stores the converted image in the storage unit 1004. In a step 308, the image conversion apparatus 103 transmits the converted image from the communication interface 1003 to the mobile terminal 101 through the transmission path 102. In a step 309, the mobile terminal 101 receives the converted image from the image conversion apparatus 103 through the antenna 206 and displays the image on the monitoring unit 203.

In a step 310, a frame for selecting an image portion to be enlarged, that is, an enlarging frame is displayed on the image appearing on the monitoring unit 203 of the mobile terminal 101. For example, by pressing the soft key 2041 of the mobile terminal 101, the enlarging frame is displayed (that is, the screen is changed into the enlarged display.)

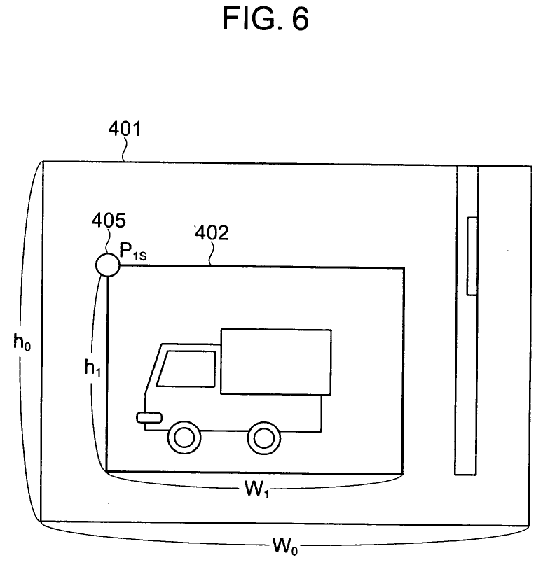

FIG. 6 shows the frame (enlarging frame) for selecting an image portion to be enlarged, which appears on the image displayed on the monitoring unit 203 of the mobile terminal 101. In FIG. 6, a numeral 401 denotes an image displayed on the monitoring unit 203 of the mobile terminal 101. A numeral 402 denotes an enlarging frame, which is used for specifying an optional enlarging location and area of an image portion to be enlarged, the location and area appearing on the image of the monitoring screen (often referred simply to as the screen) 203. In addition, the initial enlarging frame may be specified at a maximum size, for example.

In a step 311, the process is executed of moving on the image the enlarging frame 402 displayed on the monitoring unit 203 of the mobile terminal 101 and changing the size of the frame 402. For moving or changing the size of the enlarging frame 402, by handling the button (key) allocated for the movement or the size change of the enlarging frame 402, included in the button section 204 of the mobile terminal 101, the instruction is sent to the CPU 201 in which the proper operation is executed.

Herein, the operation is executed to set the coordinates of the origin point 405 of the frame 402 and the size (width w1 and height h1) of the frame 402 in FIG. 6. In FIG. 6, h0 and w0 are the height and the width of the image to be displayed on the monitoring screen of the mobile terminal 101. Further, in the following embodiment, the description will be oriented to the individual adjustments of the width and the height of the enlarging frame 402.

In this case, for example, each time the upper key 2044 of the cross key 2043 is pressed, the height of the enlarging frame 402 is increased by one step. On the other hand, each time the lower key 2045 is pressed, the height of the enlarging frame 402 is decreased by one step. Likewise, each time the right key 2046 of the cross key 2043 is pressed, the width of the enlarging frame is increased by one step. On the other hand, each time the left key 2047 is pressed, the width of the enlarging frame is decreased by one step. One step of the size corresponds to one or more dots.

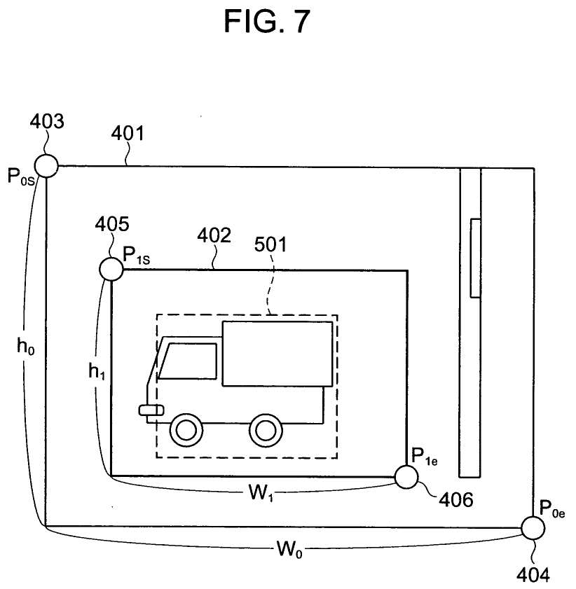

FIG. 7 shows an example of a display before changing the size of the frame 402. The display of FIG. 7 includes a frame 501 added as the previous frame 402 before changing the size to the display of FIG. 6. By handling the button section 204 as noted above, the initial frame 501 is changed into the frame 402.

For moving the enlarging frame 402, for example, each time the key of 1, 2, 3, 4, 6, 7, 8 or 9 of the numeric key pad 2042 is pressed, the enlarging frame 402 is moved by a predetermined number of (one or more) dots in the direction of the pressed numeric key from the key of 5 as the center key (the cardinal point key). That is, when the user presses the key of 1, the enlarging frame 402 is moved by one dot in the upper left direction. When the user presses the key of 6, the enlarging frame 402 is moved by one dot in the right direction. When the user presses the key of 8, the enlarging frame 402 is moved by one dot in the downward direction.

On completion of setting the size and the location of the enlarging frame 402, for example, by pressing the key 2048, the end of setting is entered.

In a step 312, on the mobile terminal 101, it is determined whether or not the process of enlarging an image is the first or the second or later one. If it is the first process of enlarging an image, the process goes to a step 314, while if it is the second or later process, the process goes to a step 313.

The process of the step 313 is executed in the second or later process of enlarging an image, the details of which will be described later.

In a step 314, the mobile terminal 101 operates to transmit a request for enlarging an image to the image conversion apparatus 103. If the user presses the corresponding button (key) with the image enlarging request, the button being included in the button section 204 of the mobile terminal 101, the CPU 201 of the mobile terminal 101 operates to transmit the image enlarging request to the image conversion apparatus 103 through the antenna 206 and the transmission path 102. At a time, the information on the location and the size of the frame 402 specified in the step 311 is also transmitted to the image conversion apparatus 103. Concretely, the coordinates of the point 405 and the size of the frame 402 (corresponding to the width and height of the frame) are transmitted at a time when the image enlarging request is transmitted. Further, the mobile terminal 101 holds in the memory 202 the coordinates of the point 405 and the width and height of the frame 402 having been transmitted to the image conversion apparatus 103.

In a step 315, the image conversion apparatus 103 receives the image enlarging request and the information on the location and the size of the frame 402. Then, the image conversion unit 1005 performs the image enlarging process according to the information. The image conversion unit 1005 cuts out the rectangular range of the frame 402 indicated by the width w1 and the height h1 of the frame 402 with the point 405 as the starting point, and then enlarges the image to the target size on the monitoring screen of the mobile terminal 101. The image conversion apparatus 103 derives a ratio h0/h1 of the height h0 of the monitoring screen to the height h1 of the frame 402 and enlarges the image within the cut frame 402 by a smaller value of the ratio h0/h1 and the ratio w0/w1. The image within the cut frame 402 may be enlarged by a larger value. In this case, however, the complete image within the frame 402 may not be fitted in the monitoring screen.

In a step 316, the image conversion apparatus 103 transmits the image enlarged in the step 315 to the mobile terminal 101.

In a step 317, the mobile terminal 101 receives the enlarged image and displays it on the screen of the monitoring unit 203.

In a step 318, it is determined whether or not the image enlarging process is to be ended. If the user of the mobile terminal 101 presses the concerned button (key) of the button section 204 for instructing the CPU 201 to continue the image enlarging process, the process goes to the step 310, while if the end of the image enlarging process is indicated, the process goes to a step 319.

In the step 319, it is determined whether or not the image viewing process is terminated.

Herein, the process of the step 313 will be described in detail.

The process of the step 313 is executed in the mobile terminal 101 if the process from the steps 310 to 318 is executed at least once and the image enlarging process is continued in the step 318. Herein, the process of the steps 310 to 318 including the process of the step 313 will be described with the second image enlarging process as an example.

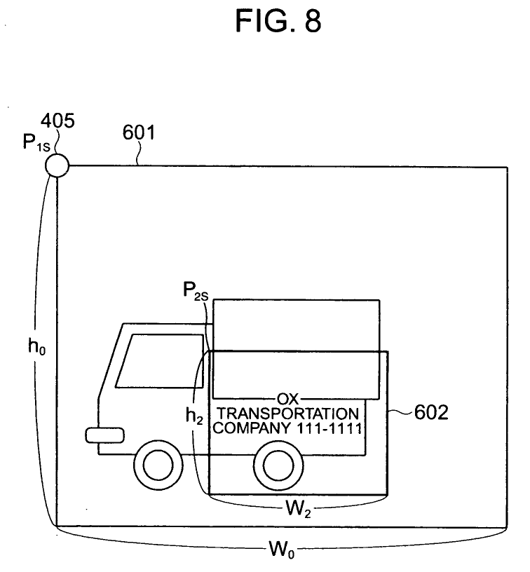

When the second process of the step 310 is executed, the screen shown in FIG. 8 appears on the mobile terminal 101. A numeral 601 denotes an image created by enlarging the partial image selectively cut by the frame 402 shown in FIG. 6 and displayed on the screen of the mobile terminal 101. A numeral 602 denotes a frame for selecting the second part to be enlarged, appearing on the image 601.

In the step 311, the similar process to the foregoing process is executed.

In the step 312, according to the determination that the second image enlarging process is executed, the process goes to the step 313.

In the step 313, the process is executed to cause the mobile terminal 101 to calculate the partial image selectively cut in the step 311 at the second time as the numeric value to the image before enlargement (see FIG. 6). The image conversion apparatus 103 holds the image obtained from the storage distribution apparatus 105 but does not hold the enlarged image. It means that the image conversion apparatus 103 holds the image before enlargement, that is, the image 401. However, the selective range of the image cut by the frame 602 in the step 311 corresponds to the image 601. Hence, the mobile terminal 101 is required to derive the selective range of the image cut by the frame from the image 401 before enlargement and then transmit the derived result to the image conversion apparatus 103.

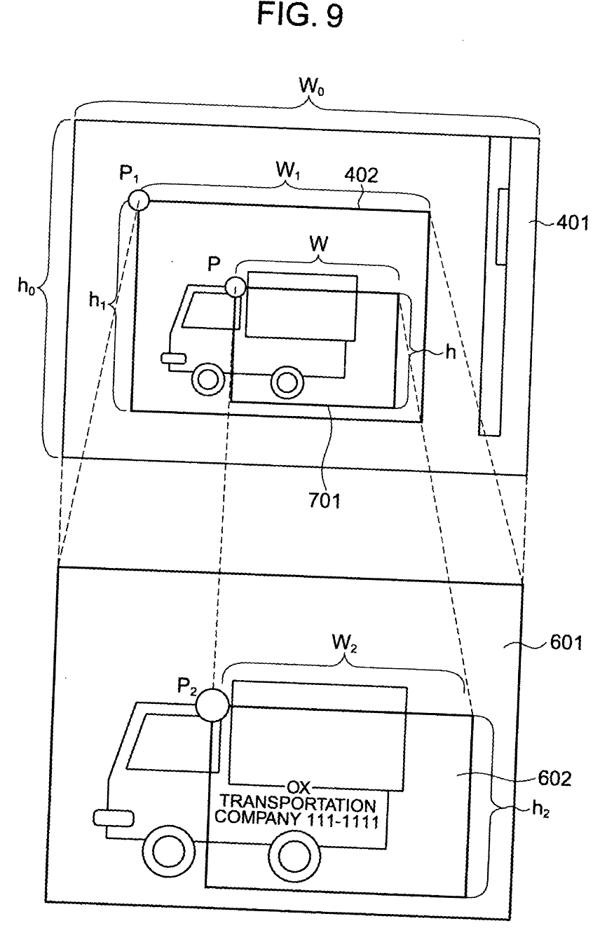

The concrete calculating method of the step 313 will be described with reference to FIG. 9.

FIG. 9 shows the correspondence between the image 601 and the frame 602 in the image 401 by ranging the image 401 shown in FIG. 6 and the image 601 shown in FIG. 8 vertically.

In FIG. 9, the width and the height of the image 401 are denotes by w0 and h0, respectively. The starting point (vertex in the upper left corner) of the frame 402 is denoted by P1 (P1x, P1y), the width of the frame 402 is denoted by w1, and the height of the frame 402 is denoted by h1. The starting point of the frame 602 is denoted by P2 (P2x, P2y), the width of the frame 602 is denoted by w2, and the height of the frame 602 is denoted by h2. The starting point of the frame 701 is denoted by P (Px, Py), the width of the frame 701 is denoted by w, and the height of the frame 701 is denoted by h.

Herein, the coordinates of P1 and the values of w1 and h1 are held in the mobile terminal 101 in the step 314. The coordinates of P2 and the values of w2 and h2 are supplied in the step 403. It means that those values are known. Moreover, the values of w0 and h0 correspond to the width and the height of the image display area of the mobile terminal 101, respectively. Hence, they are known as well.

Therefore, by representing the point P, the width w, and the height h with the known values, it is possible to obtain the selective image area cut by the frame 602 on the image 401.

At first, the coordinates of the point P is obtained.

The following relation is established from FIG. 9.

w0:w1=P2x:(PxP1x) (1)

By transforming the expression (1), the following expression is obtained.

Px=(w1/w0)P2x+P1x (2)

With respect to Py, similarly, the following relation is established.

h0:h1=P2x:(PxP1x) (3)

By transforming the expression (3), the following expression is obtained.

Py=(h1/h0)P2y+P1y (4)

Hence, the coordinates of the point P are represented as follows.

P=((w1/w0)P2x+P1x, (h1/h0)P2y+P1y) (5)

Then, the width w and the height h are obtained. The following relations are derived from FIG. 9.

w0:w1=w:w2 (6)

h0:h1=h:h2 (7)

By transforming these expressions (6) and (7), the following expressions are obtained.

w=w1w2/w0 (8)

h=h1h2/h0 (9)

As mentioned above, it is possible to calculate the selective range of the image 401 cut by the frame 602 from the expressions (5), (8), and (9).

In the step 314, the mobile terminal 101 operates to transmit to the image conversion apparatus 103 the coordinates of the starting point and the width and the height of the selective area of the image before enlargement, which were calculated in the step 313.

In the step 315, the image conversion apparatus 103 enlarges the selective area of the image to a suitable size to the monitoring screen of the mobile terminal 101.

Then, the process of the steps 316 and 317 is executed to display the enlargement of the selective image area cut by the frame 701 on the screen of the mobile terminal 101.

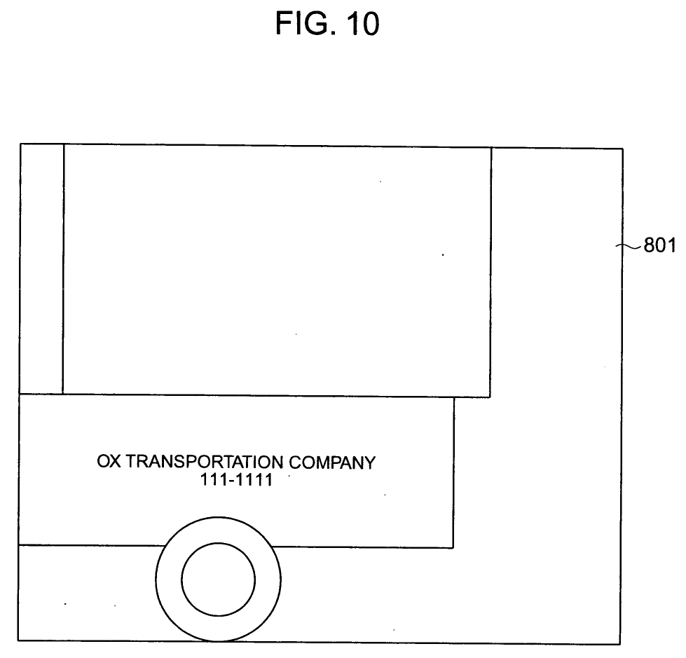

FIG. 10 shows the image created as a result of enlarging the image shown in FIG. 6 twice by the foregoing process. A numeral 801 denotes an enlargement of the selective image area cut by the frame 602 of FIG. 8, displayed on the screen of the mobile terminal 101.

Further, in the step 318, the similar process to the foregoing process is executed. By repeating the process of the steps 310 to 318 as described above, it is possible to execute the process of enlarging the same image before enlargement to respective scales in a multiple manner.

The aforementioned method makes it possible to select the portion to be enlarged from the image displayed on the screen of the mobile terminal 101. The frame may have any location and size to be adjusted. Further, by performing the calculation described with respect to the step 313, it is possible to enlarge the same image before enlargement to respective scales.

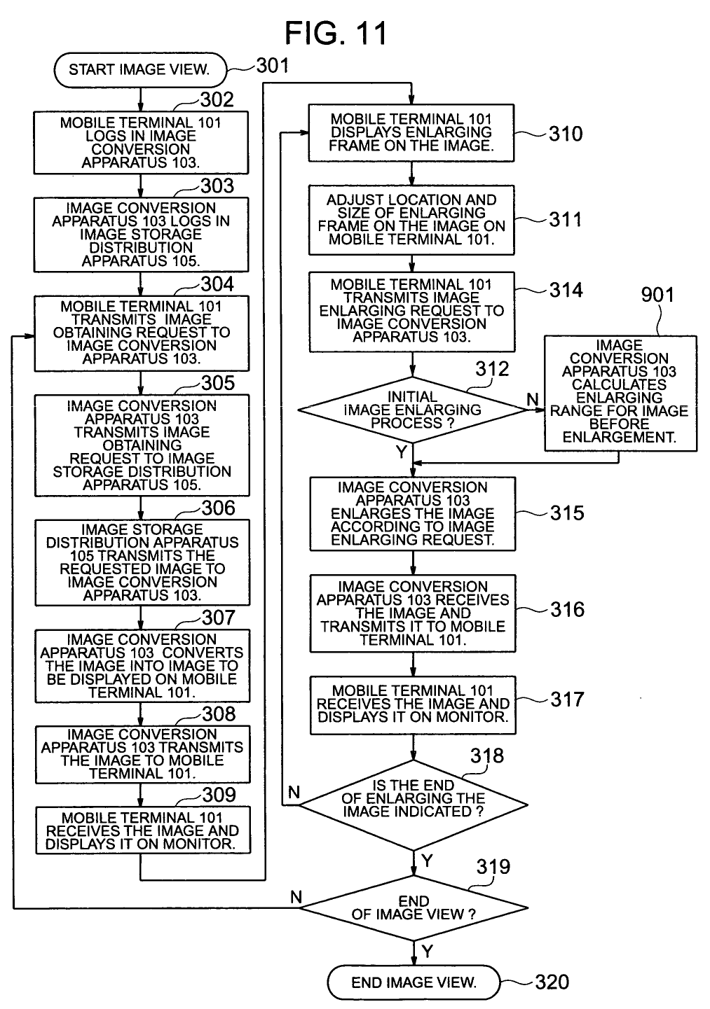

FIG. 11 is a flowchart illustrating the second method of viewing the images stored in the image storage distribution apparatus 105 through the mobile terminal 101.

In the flowchart of FIG. 11, as a different process from that of FIG. 5, the step 311 is followed by the step 314. Then, the process goes from the step 314 to the step 312 and the step 901 in place of the step 313. Next, the process goes from the step 901 to the step 315. The other process is the same as that of FIG. 5. Though, in the step 313 of FIG. 5, the mobile terminal 101 calculates from the image before enlargement the image range to be enlarged. As a prerequisite, in the step 314 of this method, when the mobile terminal 101 transmits the image enlarging request to the image conversion apparatus 101, the image conversion apparatus 103 holds the enlarged image in the storage unit 1004. Hence, in the step 901, the similar calculation to that of the step 313 of FIG. 5 is executed in the image conversion apparatus 103.

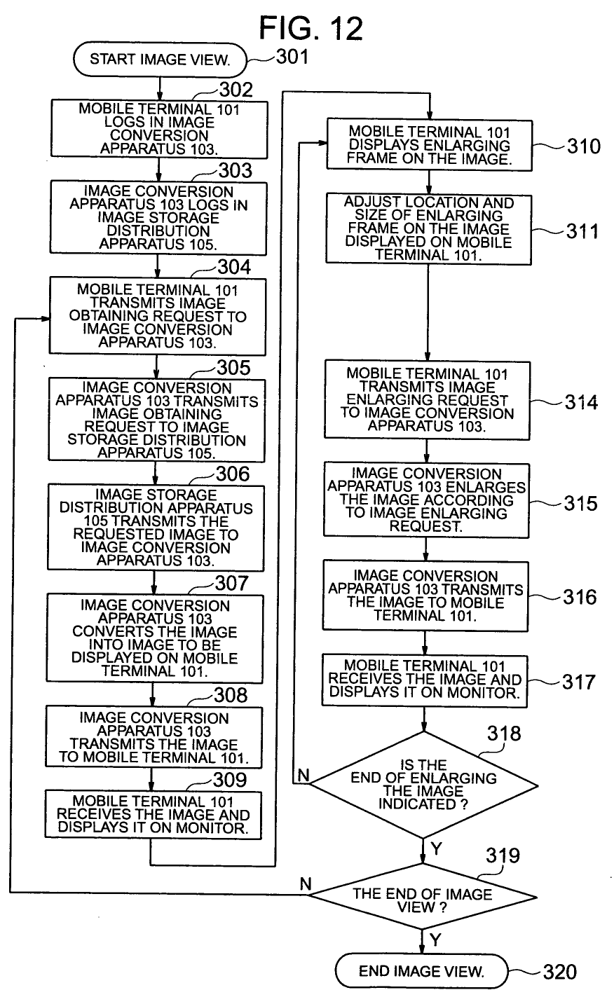

FIG. 12 is a flowchart showing the third method of viewing the images stored in the image storage distribution apparatus 105 through the mobile terminal 101.

In the flowchart of FIG. 12, as a different process from that of FIG. 5, the steps 312 and 313 are removed after the step 311. That is, the step 311 directly goes to the step 314. The other process is similar to that shown in FIG. 5.

As a prerequisite, in the step 314 of this method, when the mobile terminal 101 transmits the image enlarging request to the image conversion apparatus 103, the image conversion apparatus 103 holds the enlarged image. In the step 315, the image conversion apparatus 103 enlarges the previous enlarged image more.

That is, the third method is the process of enlarging the just previous enlarged image.

For example, the first enlarging process is executed to derive a ratio h0/h1 of the height h0 of the monitoring screen of the mobile terminal 101 to the height h1 of the frame 402 at the first time and a ratio w0/w1 of the width w0 of the monitoring screen of the mobile terminal 101 to the width w1 of the frame 402 and then to enlarge the image cut by the frame 402 by a smaller value of the ratios h0/h1 and w0/w1.

The second enlarging process is executed to derive a ratio h1/h2 of the height h1 of the frame 402 at the first time to the height h2 of the frame 602 at the second time and a ratio w1/w2 of the width w1 of the frame 402 to the width of the frame 602 and then enlarge the image cut by the frame 602 at the second time by a factor of a smaller value of these ratios h1/h2 and w1/w2.

The foregoing description has concerned with the individual adjustments of the width and the height of the enlarging frame 402. In place, the size of the enlarging frame 402 may be switched in multiple steps so that the frame 402 may be analogous to the overall screen.

As an example, the width and height of the enlarging frame 402 may be switched in five steps with respect to the width and height of the overall screen of the monitoring unit 203. Concretely, the five steps of the width and height include a pair of 1/1.5 and 1/1.5 (1/1.52 in area), a pair of ½ and ½ (¼ in area), a pair of ⅓ and ⅓ (1/9 in area), a pair of ¼ and ¼ (1/16 in area), and a pair of ⅕ and ⅕ (1/25 in area).

For example, this type of switching operation may be arranged as follows. Each time the upper key 2044 of the cross key 2043 is pressed, the enlarging frame 402 of a larger size by one step than the current size is displayed. Each time the lower key 2045 is pressed, the enlarging frame 402 of a smaller size by one step than the current size is displayed.

If the size of the enlarging frame 402 is switched in multiple steps so that the size of the frame 402 may be analogous to the overall screen size of the monitoring unit 203, for example, the image enlarging process is executed as follows.

At first, in the first method, in the step 314 of FIG. 5, the mobile terminal 101 transmits as the size of the frame 402 shown in FIG. 6 one of the width W1 and the height H1 of the frame 402, for example, the height H1 to the image conversion apparatus 103 in place of the pair of the width and the height of the frame 402.

Then, in the step 315, the process is executed to cause the image conversion apparatus 103 to derive a ratio H0/H1 of the height HO of the monitoring screen of the mobile terminal 101 to the height H1 of the frame 402 received thereby and then to enlarge the image within the frame 402 by a factor of H0/H1.

In a case that the width W1 of the frame 402 is transmitted to the image conversion apparatus 103 in place of the pair of the width and the height of the frame 402, in the step 315, the process is executed to cause the image conversion apparatus 103 to derive a ratio W0/W1 of the width W0 of the monitoring screen of the mobile terminal 101 to the width W1 of the frame 402 received thereby and then to enlarge the image by a factor of W0/W1.

Further, like the step 313 of FIG. 5, the process of the step 313, that is, the second or later enlarging process uses the pair of the width and the height of the frame. Hence, in the step 314, the pair of the width and the height of the frame is transmitted to the image conversion apparatus 103.

The second method may be arranged so that the foregoing process is executed by the image conversion apparatus 103 in place of the mobile terminal 101.

The foregoing embodiment of the invention makes it possible to more easily check the details of the image even on the narrower screen of the mobile terminal than the ordinary personal computer.

According to the foregoing embodiment of the invention, in the case of viewing on the mobile terminal the images stored in the image storage distribution apparatus, the same image may be enlarged in multiple scales. It means that the image may be viewed as gradually increasing its scale. Hence, even if the object to be checked on a once enlarged image is small for the viewer, by enlarging the image once or more times, the proper scale to the viewer may be obtained.

Moreover, the embodiment allows the location and size of the enlarging range of the image to be arbitrarily changed. This thus makes it possible to change the enlarging range as guessing the proper range.

As set forth above, the present invention makes it possible to enlarge the same image before enlargement in multiple scales. Moreover, the invention also makes it possible to enlarge the previous enlarged image more, that is, enlarge the immediately previous enlarged image more.

Further, the invention allows the mobile terminal to save the image before enlargement, enlarge the saved image, and display the enlarged image on the screen as well.

The present invention offers the image display method for a mobile terminal in the image distribution system which is arranged to display the concerned portion of the image to be viewed on the mobile terminal more clearly.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An image distribution system comprising:
an image storage distribution apparatus for storing images picked up by an imaging unit;
an image conversion apparatus for obtaining an image specified by said mobile terminal and distributing said specified image to said mobile terminal if said specified image is required to be displayed; and
said mobile terminal arranged to display said image distributed from said image conversion apparatus on a screen of a monitoring unit, specify an optional location and range of said displayed image, and transmit information on said specified location and range to said image conversion apparatus, and wherein
said image conversion apparatus enlarges the image of the location and range specified by said mobile terminal to a display size of said monitoring unit located on said mobile terminal and then distributes said enlarged image to said mobile terminal, and
said mobile terminal displays said enlarged image distributed by said image conversion apparatus on the screen of said monitoring unit.

2. An image distribution system as claimed in claim 1, wherein said mobile terminal specifies an optional location and range of said enlarged image displayed on the screen of said monitoring unit again and transmits information on said location and range specified again to said image conversion apparatus, and
said image conversion apparatus enlarges the image of said location and range specified again by said mobile terminal from said enlarged image displayed on the screen of said monitoring unit of said mobile terminal to a proper display size to said mobile terminal again and distributes said re-enlarged image to said mobile terminal, and said mobile terminal displays said re-enlarged image distributed by said image conversion apparatus on the screen of said monitoring unit.

3. An image distribution system as claimed in claim 2, wherein said image conversion apparatus obtains said enlarged image and said re-enlarged image based on the same image before enlargement or said re-enlarged image on said enlarged image.

4. An image distribution system as claimed in claim 1, wherein said mobile terminal displays an optional location and range of said image displayed on the screen of said monitoring unit with a frame and specifies the optional location and range of said image based on the handling of said frame on the screen of said monitoring unit by a user.

5. An image distribution system as claimed in claim 1, wherein said mobile terminal changes the optional location and range of said image displayed on the screen of said monitoring unit for the purpose of adjusting the location and range to be enlarged.

6. An image display method for a mobile terminal in an image distribution system, comprising the steps of:
storing images picked up by an imaging unit in an image storage distribution apparatus;
if said mobile terminal requests an image specified by said mobile terminal to be displayed, causing said image conversion apparatus to obtain said specified image from said image storage distribution apparatus and then to distribute said specified image to said mobile terminal;
causing said mobile terminal to display said image distributed by said image conversion apparatus on the screen of a monitoring unit located in said mobile terminal;
causing said mobile terminal to specify an optional location and range of said displayed image and transmit information on said specified location and range to said image conversion apparatus;
causing said image conversion apparatus to enlarge the image of said location and range specified by said mobile terminal from the image specified by said mobile terminal to a proper display size to said monitoring unit of said mobile terminal and then to distribute said enlarged image to said mobile terminal; and
causing said mobile terminal to display said enlarged image distributed by said image conversion apparatus on the screen of said monitoring unit.

7. An image display method as claimed in claim 6, further comprising the steps of:
causing said mobile terminal to specify an optional location and range of said enlarged image displayed on the screen of said monitoring unit again and then to transmit information on said re-specified location and range to said image conversion apparatus;
causing said image conversion apparatus to enlarge the image of said location and range re-specified by said mobile terminal from said enlarged image displayed on the screen of said monitoring unit of said mobile terminal to a proper display size of said mobile terminal again and then to distribute said re-enlarged image to said mobile terminal; and
causing said mobile terminal to display said re-enlarged image distributed by said image conversion apparatus on the screen of said monitoring unit.

8. An image display method as claimed in claim 6, wherein said image conversion apparatus obtains said enlarged image and said re-enlarged image based on the same image before enlargement or said re-enlarged image based on said enlarged image.

9. An image display method as claimed in claim 6, wherein said mobile terminal displays an optional location and range of said image displayed on the screen of said monitoring unit with a frame and specifies the optional location and range of said image based on the handling of said frame on the screen of said monitoring unit by a user.

10. An image display method as claimed in claim 6, wherein said mobile terminal changes the optional location and range of said image displayed on the screen of said monitoring unit for the purpose of adjusting the enlarging location and range.

11. A mobile terminal comprising:
a monitoring unit for displaying an image distributed and received from the outside through a transmission path;
a storage unit for storing the process comprising the steps of:
specifying an optional location and range of said displayed image and transmitting information on said specified location and range to the outside;
receiving an image of said specified location and range enlarged to a proper display size to said monitoring unit of said mobile terminal; and
displaying said enlarged image displayed from said image conversion apparatus on the screen of said monitoring unit.

12. A mobile terminal as claimed in claim 11, wherein
said storage unit further stores the process comprising the steps of:
specifying an optional location and range of said enlarged image displayed on the screen of said monitoring unit again and transmitting information on said re-specified location and range to the outside;
receiving the image of said location and range re-specified by said mobile terminal from said enlarged image displayed on the screen of said monitoring unit, said received image being enlarged to a proper display size to said mobile terminal again; and
displaying said received and re-enlarged image on the screen of said monitoring unit.

13. A mobile terminal as claimed in claim 12, wherein said enlarged image or said re-enlarged image is obtained on the same image before enlargement, or said re-enlarged image is obtained on said enlarged image.

14. A mobile terminal as claimed in claim 11, wherein said storage unit further stores the process comprising the step of:
displaying an optional location and range of said image displayed on the screen of said monitoring unit with a frame and specifying the optional location and range of said image based on the handling of said frame on the screen of said monitoring unit by a user.

15. A mobile terminal as claimed in claim 11, wherein said storage unit further stores the process comprising the step of:
changing an optional location and range of said image displayed on the screen of said monitoring unit, for the purpose of adjusting the enlarging location and range.

16. An image conversion apparatus comprising:
an interface for receiving information distributed from the outside through a transmission path and distributing the information to the outside; and
a storage unit for storing the process comprising the steps of:
if a mobile terminal requests an image specified by said mobile terminal itself to be displayed, obtaining said specified image, distributing said specified image to said mobile terminal, and displaying said specified image on a monitoring unit of said mobile terminal; and
when receiving information on the specified location and range of said displayed image from said mobile terminal, enlarging the image of a location and range specified by said mobile terminal from the image specified by said mobile terminal to a proper display size to said monitoring unit of said mobile terminal, distributing said enlarged image to said mobile terminal, and then causing said mobile terminal to display said enlarged image on said monitoring unit.

17. An image conversion apparatus as claimed in claim 16, wherein said storage unit further stores the process comprising the steps of:
causing said mobile terminal to receive information on said re-specified optional location and range of said enlarged image displayed on the screen of said monitoring unit; and
enlarging an image of the location and range re-specified by said mobile again from said enlarged image displayed on the screen of said monitoring unit of said mobile terminal to a proper display size to said mobile terminal again, displaying said re-enlarged image to said mobile terminal, and displaying said re-enlarged image on the screen of said monitoring unit.

18. An image conversion apparatus as claimed in claim 17, wherein said enlarged image or said re-enlarged image is obtained on the same image before enlargement or said re-enlarged image is obtained on said enlarged image.
